(19) United States
(12) Patent Application Publication
(10) Pub. No.: US 2012/0303146 A1
(43) Pub. Date: Nov. 29, 2012

(54) Sound Enhancer For Portable Media Player

(75) Inventors: Toly Genov, San Jose, CA (US); Zlatko Manolov Sotirov, Santa Clara, CA (US); Marlowe Markov, Los Angeles, CA (US); Alex Todorov, Santa Clara, CA (US)

(73) Assignee: ROMULUS INVESTMENTS LLC, Saratoga, CA (US)

(21) Appl. No.: 13/114,813

(22) Filed: May 24, 2011

(51) Int. Cl. G06F 17/00

(52) U.S. Cl. 700/94

(57) ABSTRACT

In one embodiment, a sound enhancer is couplable to a portable media player and is configured to redirect sound from a speaker of the portable media player towards a user for enhancing the user's audio experience. The sound enhancer may direct sound from a side-mounted or back-mounted speaker, and include features such as a loudspeaker to amplify the sound, and various reflectors, directing channels and resonant cavities. A gripper is provided to provide secure attachment to the portable media player. Alternatively, the sound enhancer can be formed integrally with accessories of the portable media player such as a hard or soft case, a docking station, and holder or stand and the like.

### TECHNICAL FIELD

The present disclosure relates generally to portable media devices such as personal digital assistants (PDAs), mobile phones, tablet-computers, laptop computers and proprietary devices including the iPAD™ and the like.

### BACKGROUND

Portable electronic devices with build-in speakers are becoming increasingly popular. Because of their compact size, their speakers are small and often placed in the back or on a side of the device. As a result, the sound waves they generate do not reach the listener directly, but instead assume a tortuous path involving upon reflections from surrounding objects. The surrounding objects are not optimally configured or constituted to best reflect these waves, often absorbing or misdirecting much of the sound, and doing so in ways that vary with the position of the objects relative to the mobile portable electronic device. This degrades sound quality and detracts from the listener's experience in dynamic and unpredictable ways.

### OVERVIEW

As described herein, a sound enhancer couplable to a portable media player includes an attacher configured to attach the sound enhancer to the portable media player in a confronting relationship with a speaker of the portable media player and a directing assembly configured to change a direction of propagation of sound from the speaker of the portable media device.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a schematic diagram showing the acoustic components of a sound enhancer 100 in accordance with one embodiment;

FIGS. 2 and 3 are respectively isometric and cross-sectional side elevational views of a sound enhancer 200 in accordance with one embodiment;

FIG. 4 is a schematic diagram showing operation of a sound enhancer;

FIG. 5 is a diagram showing the use of a sound enhancer with and without a case of a portable media player;

FIG. 6 shows a sound enhancer without a directing channel;

FIG. 7 is a schematic diagram showing attachment/detachment of a sound enhancer to a portable media player;

FIGS. 8a and 8b illustrate an embodiment in which the sound enhancer 810 is designed as an add-on to a mobile phone 820, and shown singularly (FIG. 8a) and coupled to the mobile phone (FIG. 8b);

FIG. 9 is a schematic diagram of a sound enhancer 900 configured to redirect sound 180 degrees, for operation with a portable media player 902 having a rear-mounted speaker 904;

FIGS. 10a and 10b are directed to an arrangement in which the sound enhancer 1002 is an integral part of a hard case 1004 for protecting a portable media player in the form of a tablet computer 1006;

FIG. 11 is directed to an arrangement in which the sound enhancer 1120 is an integral part of a hard case 1124 for protecting a portable media player in the form of a mobile telephone 1106;

FIGS. 12a to 12c show a sound enhancing add-on component 1220 (holder or stand) to a docking station 1210 for a portable media player such as an iPad™; and

FIG. 13 illustrates an approach for further enhancing the sound reflecting and “amplifying” performance of the device shown in FIGS. 12a to 12c.

### DESCRIPTION OF EXAMPLE EMBODIMENTS

Example embodiments are described herein in the context of a device for enhancing sound for portable media players. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

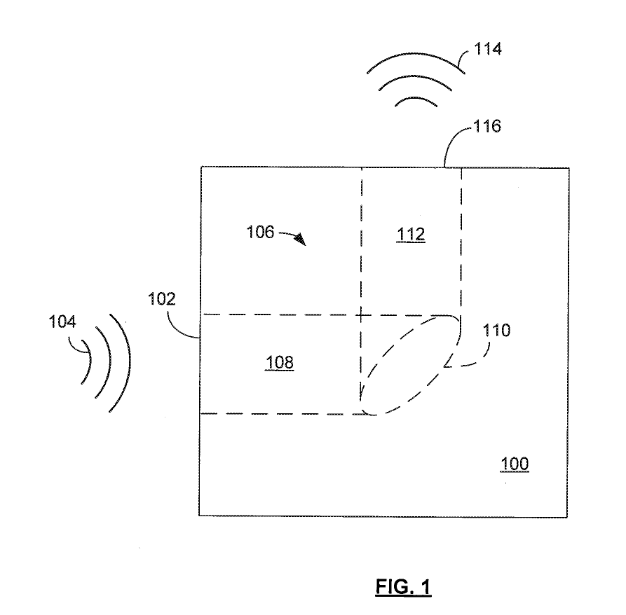

FIG. 1 is a schematic diagram showing mainly the acoustic components of a sound enhancer 100 in accordance with one embodiment. These acoustic components include an input port 102 for receiving sound 104 that is generated by a speaker from for example a portable media player (not shown). From input port 102, the sound enters a directing assembly generally designated 106, which may include one or more directing channels 108, reflectors 110, and resonant cavities 112. The sound 114 then exits enhancer 100 at exit port 116.

Directing assembly 106 in the FIG. 1 example changes the direction of propagation of the sound received by sound enhancer 100 by 90 degrees. Angle changes other than 90 degrees are also contemplated, including any angles more than 0 degrees and up to 180 degrees. Infinite arrangements of directing channels, reflectors and resonant cavities can provide such a range of angle changes, and not all of these components are necessary for operation. For example, it may be possible to omit the use of a directing channel, coupling the reflector and resonant cavity directly to the input port. In addition, the shapes and constitution of the various components can be varied. Sound reflectors that have flat, curved, parabolic, hyperbolic and complex shapes and reflecting surfaces depending on the application, desired compactness, shape, form factor and so on are contemplated.

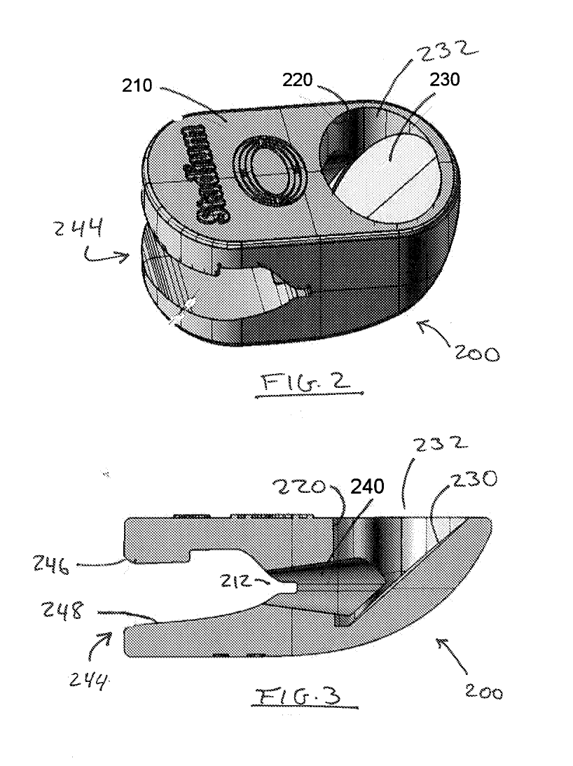

FIGS. 2 and 3 are respectively isometric and cross-sectional side elevational views of a sound enhancer 200 in accordance with one embodiment. The arrangement of FIGS. 2 and 3 include a housing 210 in which are formed input port 212, directing channel 240, resonant cavity 220, reflector 230, and exit port 232. Also included is an attacher, in the form of gripper 244, operative to attach sound enhancer 200 to a portable media player (not shown), and generally taking the shape of a pair of confronting resiliently-mounted pads 246, 248 that clamp onto opposing sides of a portable media player (not shown). Suitable materials for the gripper include rubber, plastic and the like. Other attachment means are also contemplated, such as screws and fasteners, adhesive, tabs, clips (hinged or otherwise), and the like.

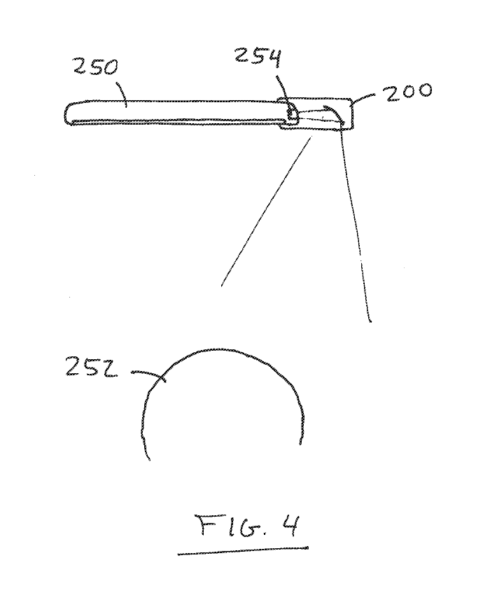

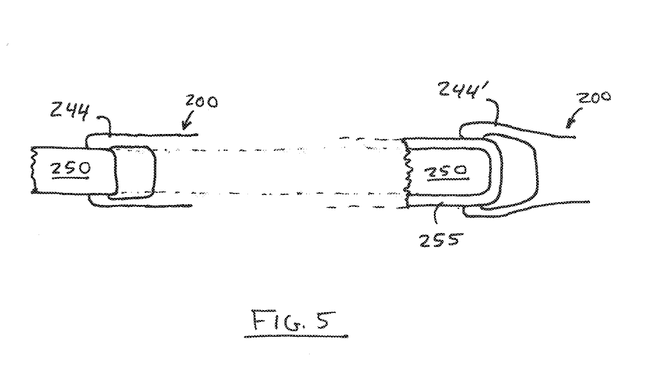

Sound enhancer 200 serves to change the sound propagation angle by 90 degrees, and is configured for operation with a portable media player having a side-mounted speaker. Such operation is described with reference to FIG. 4, in which sound enhancer 200 is shown coupled to portable media player 250 that is being operated by operator 252. Sound from side-mounted speaker 254 is received by sound enhancer 200 and is redirected by 90 degrees towards operator 252. The body or housing of sound enhancer 200 may be made of a single piece of material with elastic properties, particularly the gripper portion 244, or it may be made of separate and housing and gripper portions having the same or different material properties. The directing channel 240 is tapered to improve the coupling efficiency between the speaker-driver and the air. The resonant cavity 220 serves as an acoustic transformer that provides impedance matching between the relatively dense diaphragm material of the speaker and the air of low density. The reflective surface 230 in this particular example is a surface of a paraboloid of revolution with a focal point disposed in a close vicinity of the most common location of the operator (approximately 10-12 inches in front of the device in the case of the iPad™). The gripper portion 244 is deformable and has a profile such that it can accommodate or grip a bare portable media player or one that is clad in a protective covering or case, relying on the deformation properties of the gripper material to enable it to adjust to the different thicknesses of the bare vs. clad player, as illustrated in FIG. 5. In the left-hand portion of FIG. 5, a bare player 250 is shown gripped by a gripper 244 of sound enhancer 200, while in the right-hand side, player 250 clad in a case 255 is show gripped by the same gripper, in a more open configuration of the gripper designated 244′. The gripper 244 is provided with negative geometrical tolerances so that the gripper material is suitably deformed by the portable media player to thus create gripping forces that keep the sound enhancer 200 securely attached in place.

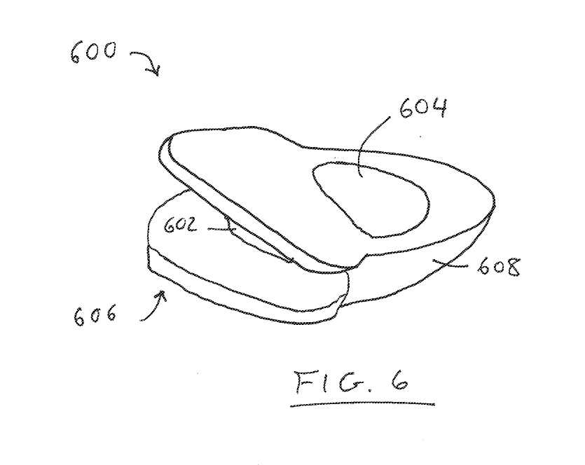

FIG. 6 is directed to a sound enhancer 600 in which the sound directing channel is omitted, and the entry port 602 is coupled directly to resonant cavity 604. Such an arrangement, in which gripper 606 is closer to main body 608 of the sound enhancer, may be especially useful to achieve a compact overall arrangement in limited space, such as when the portable media player is docked in a docking station (not shown).

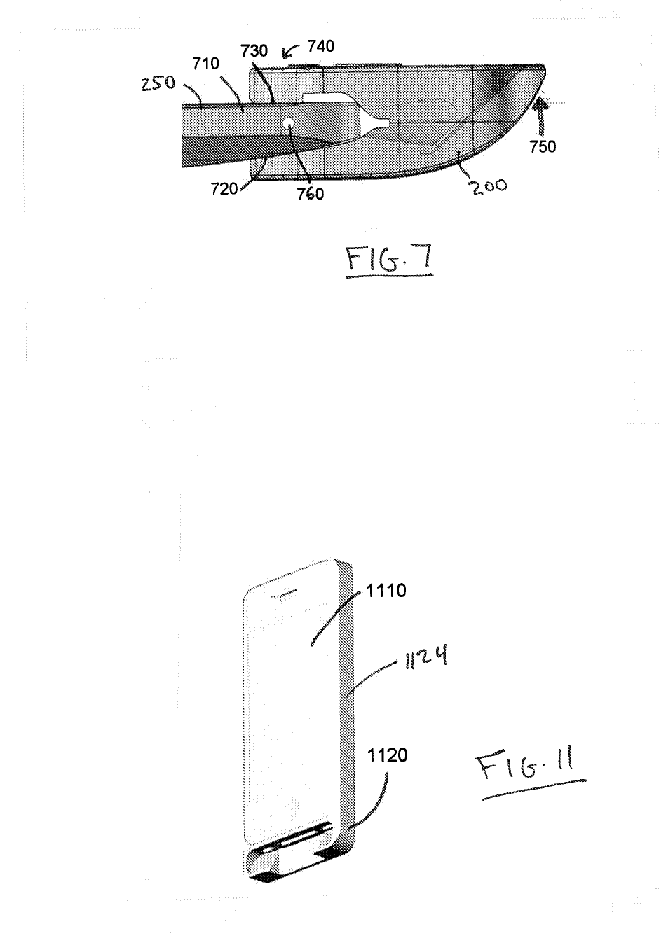

FIG. 7 illustrates an approach to attaching the sound enhancer 200 to the portable media player 250 by way of gripping. The intersections 720 and 730 of the portable media player side-surface 710 and the gripper 740, define the amount of deformation of the gripper resulting in generation of gripping forces. Also illustrated is a possible way of removing the sound enhancer from the portable media player by applying a force 750 in the “back to front” direction which makes the sound enhancer rotate around the point 760, situated in the griping-area. The removal force overcomes the gripping forces and deforms the gripper so as to disengage the sound enhancer from the portable media player.

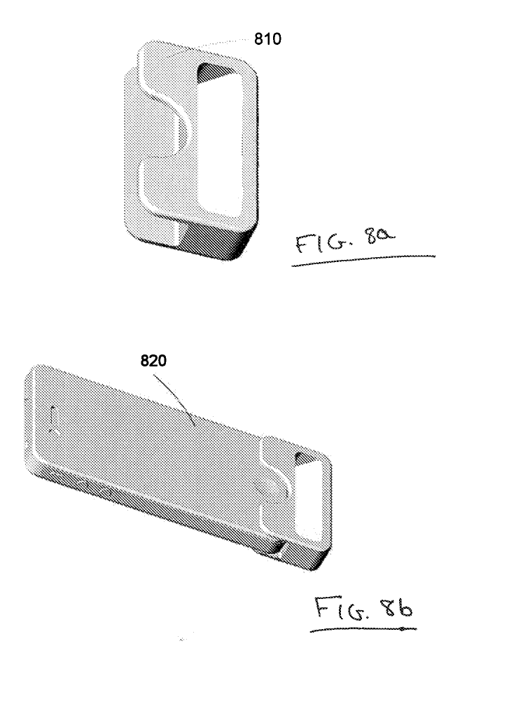

FIGS. 8a and 8b illustrate another embodiment in which the sound enhancer 810 is designed as an add-on to a mobile phone 820, and shown singularly (FIG. 8a) and coupled to the mobile phone (FIG. 8b). The principle of operation is the same as that described above.

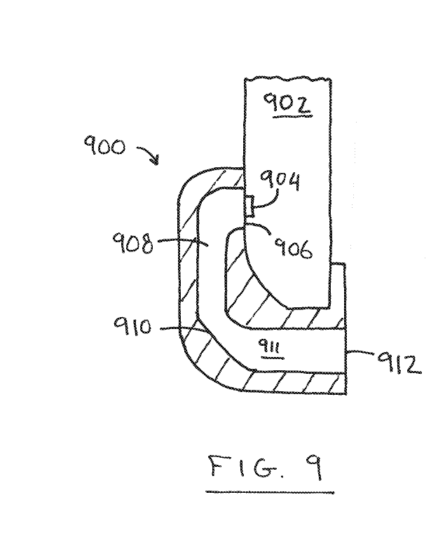

FIG. 9 is a schematic diagram of a sound enhancer 900 configured to redirect sound 180 degrees, for operation with a portable media player 902 having a rear-mounted speaker 904. Enhancer 900 includes an input port 906 for receiving sound from speaker 904, a directing channel 908 for passing the received sound to reflector 910, and a resonant cavity 911 serving as an acoustic transformer that provides impedance matching between the relatively dense diaphragm material of the speaker and the relatively lower density air. An exit ports 912 then passes the sound to the operator (not shown) at the front of the portable media player. Attachment of sound enhancer 900 to portable media player 902 is by way of a tab 914 which clips over the front surface of the media player 902 and, together with the body of the enhancer, exerts sufficient pressure on the media player to keep it in place. Other means of attachment such as fasteners, screws, adhesive and the like are also contemplated.

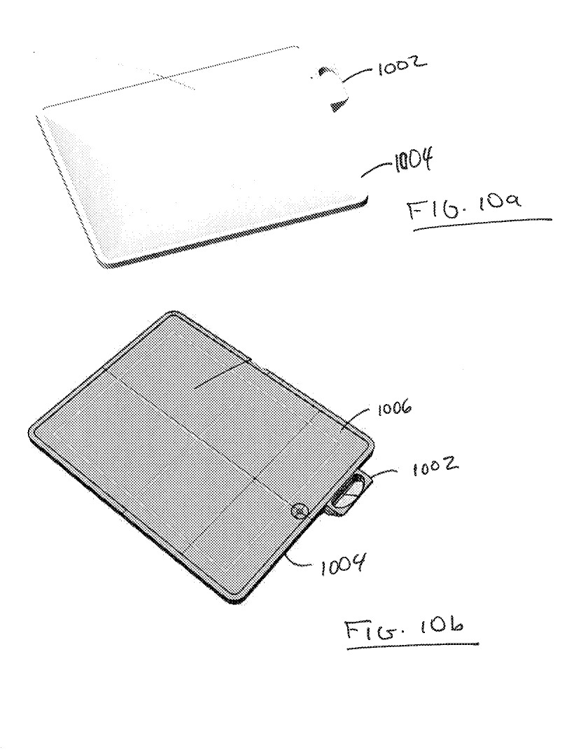

FIGS. 10a and 10b are directed to an arrangement in which the sound enhancer 1002 is an integral part of a hard case 1004 for protecting a portable media player in the form of a tablet computer 1006. The arrangement is depicted without the portable media player in FIG. 10a, and with the portable media player in FIG. 10b.

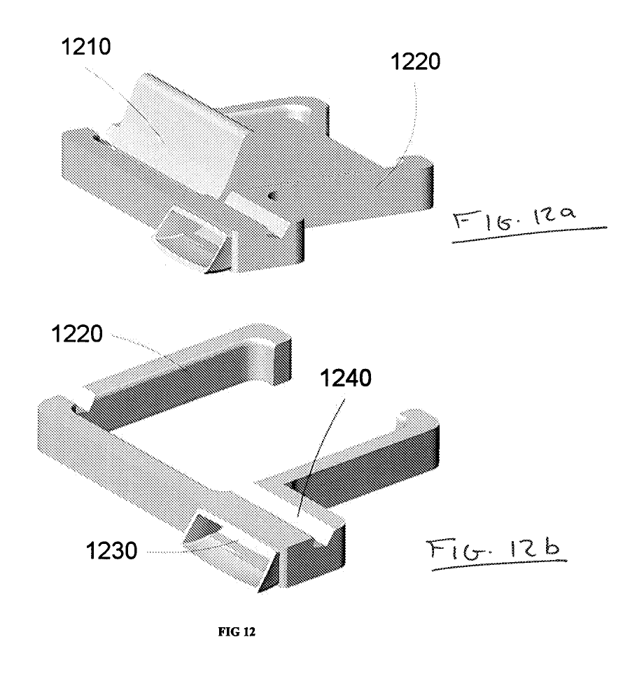

FIG. 11 is directed to an arrangement in which the sound enhancer 1120 is an integral part of a hard case 1124 for protecting a portable media player in the form of a mobile telephone 1106. Because of the compact shape, a minimal or non-existing directing channel dimension is utilized.

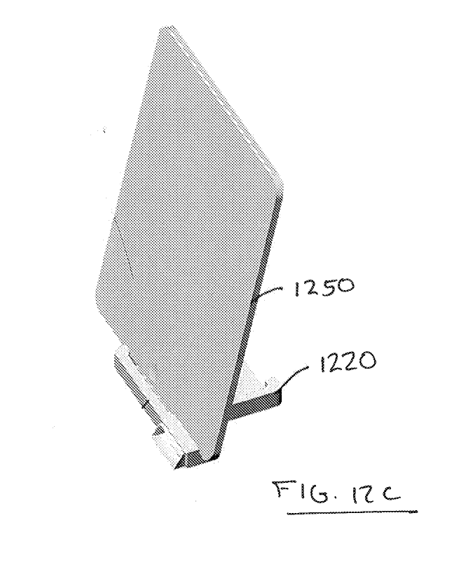

FIGS. 12a to 12c show a sound enhancing add-on component 1220 (holder or stand) to a docking station 1210 for a portable media player such as an iPad™. The holder 1220 consists of a single body with a slot 1240 for receiving the portable media player, and having a sound enhancer 1230 integrally formed therewith. In one embodiment, the holder and/or enhancer can be formed integrally with the docking station. In one embodiment, the holder is a car holder. The geometry of the slot 1240 and the sound enhancer is designed in such a way so as to form a cavity (with the portable media player installed) preserving the air-pressure and to appropriately direct the sound-waves to the operator (not shown). The digital media player 1250 is shown coupled to the holder 1220 in FIG. 12c.

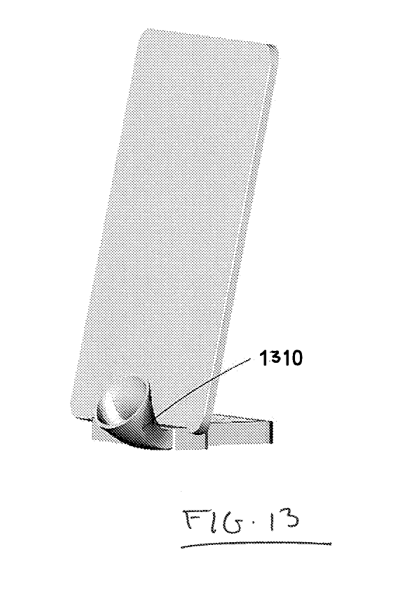

FIG. 13 illustrates an approach for further enhancing the sound reflecting and “amplifying” performance of the device shown in FIGS. 12a to 12c. A horn loudspeaker 1310 is added to the sound enhancer in order to improve the coupling efficiency between the speaker driver and the air.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A sound enhancer couplable to a portable media player comprising:
an attacher configured to attach the sound enhancer to the portable media player in a confronting relationship with a speaker of the portable media player; and
a directing assembly configured to change a direction of propagation of sound from the speaker of the portable media device.

2. The sound enhancer of claim 1, wherein the directing assembly includes:
an input port;
a reflector in communication with the input port;
a resonant cavity in communication with the reflector; and
an exit port in communication with the resonant cavity.

3. The sound enhancer of claim 2, wherein the directing assembly further includes a directing channel in communication with the input port.

4. The sound enhancer of claim 1, wherein the direction change is more than 0 and up to about 180 degrees.

5. The sound enhancer of claim 1, wherein the direction change is about 90 degrees.

6. The sound enhancer of claim 1, wherein the direction change is about 180 degrees.

7. The sound enhancer of claim 2, wherein the reflector is paraboloid.

8. The sound enhancer of claim 2, wherein the paraboloid is an elliptic paraboloid.

9. The sound enhancer of claim 2, wherein the paraboloid is a hyperbolic paraboloid.

10. The sound enhancer of claim 2, wherein the paraboloid is a paraboloid of revolution with its focal-point in a close vicinity of an operator's ear.

11. The sound enhancer of claim 2, wherein the reflector has a reflective surface that is an ellipsoid with a first focal-point in a close vicinity of the speaker and a second focal-point in a close vicinity of an operator's ear.

12. The sound enhancer of claim 2, wherein the directing channel has a tapered shape.

13. The sound enhancer of claim 1, wherein the portable media player is a tablet.

14. The sound enhancer of claim 1, wherein the portable media player is a mobile phone.

15. The sound enhancer of claim 1, wherein the attacher is a gripper.

16. The sound enhancer of claim 1, wherein the attacher is a clamp, fastener, or clip.

17. The sound enhancer of claim 1, wherein the attacher is made of elastic material having an opening for attaching to the portable media player, the said opening being smaller than the width of the part of the portable media player that inserts to it, the elastic material configured to deform to there thereby generate gripping forces to retain the sound enhancer against the portable media player.

18. The sound enhancer of claim 1, further including a loudspeaker.

19. The sound enhancer of claim 1, said sound enhancer being part of a case for protecting the portable media player.

20. The sound enhancer of claim 1, said sound enhancer being part of a docking station for the portable media player.

22. The sound enhancer of claim 1, said sound enhancer being part of a docking station for the portable media player.

21. The sound enhancer of claim 1, said sound enhancer being part of a holder for the portable media player.

22. The sound enhancer of claim 21, wherein the holder is a car holder.
